(19) United States
(12) Patent Application Publication
(10) Pub. No.: US 2007/0122532 A1
(43) Pub. Date: May 31, 2007

(54) Method of preserving fish

(76) Inventor: Chun-Hsiung Tsai, Kaohsiung (TW)

Correspondence Address: PEARL COHEN ZEDEK LATZER, LLP, 1500 BROADWAY 12TH FLOOR, NEW YORK, NY, 10036, US

(21) Appl. No.: 11/289,359

(22) Filed: Nov. 30, 2005

(51) Int. Cl. A23B 4/06

(52) U.S. Cl. 426/393

(57) ABSTRACT

A method of preserving fish includes: cleaning a fish and preparing a fillet from the fish; removing a blood line from the fillet by forming the fillet with a shallow cut along the blood line, the blood line extending along a lateral side of the fish proximate to a skin of the fish; packing the fillet in a vacuumed package which includes oxygen and which has a vacuum pressure ranging from 80% to 95% of atmosphere; and freezing the packaged fillet.

### BACKGROUND OF THE INVENTION

1. Field of the Invention

The invention relates to a method of preserving fish, more particularly to a method of preserving fish in a vacuum package including oxygen and having a predetermined vacuum pressure.

2. Description of the Related Art

Fish meat is susceptible to bacterial spoilage. Therefore, fresh fish must be subjected to proper preservation treatments after harvesting in order to preserve freshness.

The most extensively adopted preservation treatments include bleeding, sterilizing, and low-temperature storing (e.g., cold storing or freezing) to help maintain the freshness and luster of fish meat. Thereafter, the fish is packaged and transported in cold storage so as to preserve the freshness of the fish meat for an extended period.

Fish packaging techniques generally include vacuum packaging and modified or controlled atmosphere packaging. In comparison, vacuum packed fish meat is prone to color changes and an escape of tissue exudates from the fish meat.

Moreover, vacuum packed fish meat may be contaminated by anaerobes, such as Clostridium botulinum. If the vacuum packed fish meat is inadvertently exposed to a temperature exceeding 4° C., anaerobic Clostridium botulinum will breed to decompose the fish meat, thereby resulting in bad odor, decoloration and putrification of the fish meat. Furthermore, Clostridium botulinum may build up in the fish meat before color change of the fish meat is observable, thereby posing a serious threat to consumers.

In addition, as the vacuum package needs to be opened for thawing the fish meat, once the fish meat comes into contact with the air after the vacuum package is opened for thawing, bacteria may breed to contaminate the fish meat.

In view of the aforesaid problems associated with vacuum packed fish meat, controlled or modified atmosphere packaging of fish products is becoming more and more popular, and invites research and development.

The applicant has proposed a method of preserving a fish meat product in a co-pending U.S. patent application Ser. No. 11/156,456 to overcome the aforesaid problems, which has earned good reception in the marketplace and among consumers. However, the applicant noted that when the fish meat is preserved in a substantially vacuum environment containing an oxygen-containing gas, the freshness and color of the fish meat at the thickest part, i.e., the meat along the bloodline (i.e., the strip of dark red meat extending along the lateral sides of the fish near the skin) is not satisfactory. Therefore, there is still room for improvement.

### SUMMARY OF THE INVENTION

Therefore, the object of the present invention is to provide a method of preserving fish, which can inhibit growth of both aerobic and anaerobic bacteria to thereby preserve the freshness of the fish.

According to this invention, a method of preserving fish includes:

(a) cleaning a fish and preparing a fillet from the fish;

(b) removing a blood line from the fillet by forming the fillet with a shallow cut along the blood line, the blood line extending along a lateral side of the fish proximate to a skin of the fish;

(c) packing the fillet in a vacuumed package which includes oxygen and which has a vacuum pressure ranging from 80% to 95% of atmosphere; and

(d) freezing the packaged fillet.

### BRIEF DESCRIPTION OF THE DRAWINGS

Other features and advantages of the present invention will become apparent in the following detailed description of the preferred embodiment with reference to the accompanying drawings, of which:

FIG. 1 is a flowchart illustrating the preferred embodiment of a method of preserving fish according to this invention;

FIG. 2 is a schematic perspective view of a fillet prepared from the fish; and

FIG. 3 is a sectional side view showing the fillet with the blood line removed therefrom.

### DETAILED DESCRIPTION OF THE PREFERRED EMBODIMENT

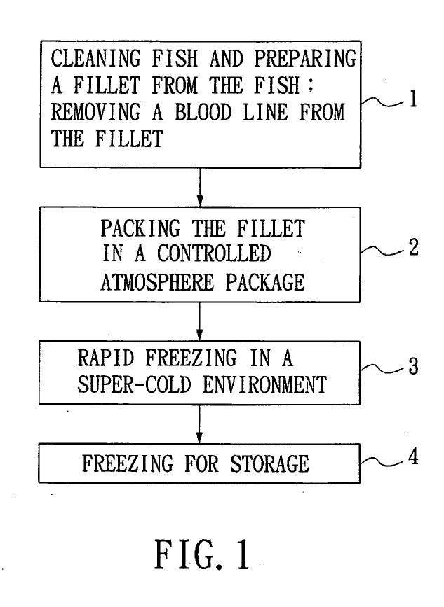

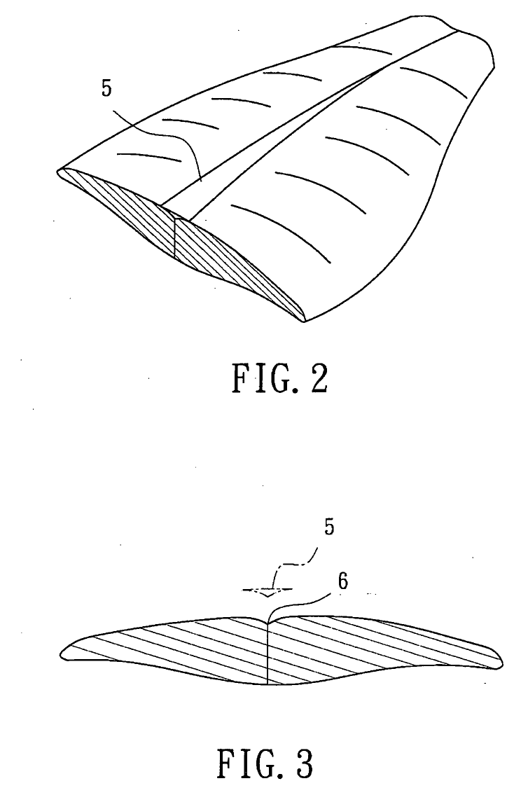

Referring to FIG. 1, the preferred embodiment of a method of preserving fish according to the present invention is shown to include steps 1 to 4. The method is mainly used for fish whose meat is relatively thin after skinning, such as Taiwan porgy, cobia, greater amberjack, salmon, tuna, etc. Step 1 of this method includes cleaning the fish and preparing a fillet from the fish in a low-temperature environment. The cleaning of the fish includes skinning, viscerating, and sterilizing. The fillet prepared from the fish is shown in FIGS. 2 and 3. A blood line 5 that extends along a lateral side of the fish proximate to the skin is removed from the fillet by forming the fillet with a shallow cut 6 along the blood line 5. The blood line 5 refers to a meat part of the fish that has a dark red color and that contains a lot of blood. The blood line 5 is removed because the part of the fillet along the blood line 5 is thick, and the subsequent preservation steps, i.e., steps 2 to 4, are unable to provide desirable good results at this part. Preferably, the shallow cut 6 is V-shaped in order to obtain a nice and neat appearance.

In step 2, the sterilized fillet is packed in a sterilized package which is vacuumed, which is subsequently filled with a predetermined amount of oxygen, preferably pure oxygen, and which has a vacuum pressure ranging from 80% to 95% of atmosphere before sealing. Thus, the fish fillet can be preserved in a controlled atmosphere containing a predetermined amount of oxygen so as to effectively prevent breeding of both aerobic and anaerobic bacteria/microorganisms, thereby preserving the freshness of the fish fillet. In this embodiment, the vacuum pressure in the vacuumed package ranges from 720 mmHg to 700 mmHg. Furthermore, the vacuumed package may include air, or oxygen in admixture with nitrogen and carbon dioxide preferably in a ratio of 5:4:1

In step 3, the packaged fish fillet is frozen quickly in a super-cold environment having a temperature ranging from −60° C. to −70° C. so as to further inhibit growth of bacteria.

In step 4, the frozen fish fillet package is stored in a freezing environment having a temperature ranging from −20° C. to −60° C.

In this invention, since the fish fillet is stored in a vacuumed package including oxygen and having a vacuum pressure ranging from 80% to 95% of atmosphere, growth of both aerobic and anaerobic bacteria inside the package can be inhibited to preserve the freshness of the fish fillet. Furthermore, as the package contains a suitable amount of air therein, the fish fillet can be thawed in the refrigerator or at room temperature with the package intact to prevent contamination of the fish fillet by bacteria. In addition, since the blood line is removed from the fish fillet to reduce the thickness of the fish meat at that part, oxygen present in the package can penetrate substantially throughout the fish fillet to help maintain the freshness and color of the fish meat, thereby rendering the fish fillet more appealing to consumers. Thus, the drawbacks associated with the prior art can be effectively eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method of preserving fish, comprising:
(a) cleaning a fish and preparing a fillet from the fish;
(b) removing a blood line from the fillet by forming the fillet with a shallow cut along the blood line, the blood line extending along a lateral side of the fish proximate to a skin of the fish;
(c) packing the fillet in a vacuumed package which includes oxygen and which has a vacuum pressure ranging from 80% to 95% of atmosphere; and
(d) freezing the packaged fillet.

2. The method as claimed in claim 1, wherein the cut is V-shaped.

3. The method as claimed in claim 1, wherein the vacuum pressure in the vacuumed package ranges from 720 mmHg to 700 mmHg.

4. The method as claimed in claim 3, wherein, in step (d), the vacuumed package is frozen quickly in a super-cold environment having a temperature ranging from −60° C. to −70° C.

5. The method as claimed in claim 4, wherein the vacuumed package is further stored in a freezing environment having a temperature ranging from −20° C. to −60° C. after being frozen at the temperature of −60° C. to −70° C.

6. The method as claimed in claim 1, wherein, in step (c), the vacuumed package includes air.

7. The method as claimed in claim 1, wherein, in step (c), the vacuumed package includes oxygen in admixture with carbon dioxide and nitrogen.

8. The method as claimed in claim 1, wherein, in step (c), the vacuumed package includes pure oxygen.

9. The method as claimed in claim 1, wherein the fillet is sterilized in step (a).
